(19) United States
(12) Patent Application Publication
(10) Pub. No.: US 2010/0034732 A1
(43) Pub. Date: Feb. 11, 2010

(54) Hydrogen production method

(76) Inventors: Robert A. Huggins, Stanford, CA (US); Yi Cui, Sunnyvale, CA (US); Riccardo Ruffo, Bresso (IT); Fabio La Mantia, Palermo (IT)

Correspondence Address: LUMEN PATENT FIRM, 350 Cambridge Avenue, Suite 100, PALO ALTO, CA, 94306, US

(21) Appl. No.: 12/454,389

(22) Filed: May 14, 2009

Related U.S. Application Data
(60) Provisional application No. 61/127,922, filed on May 16, 2008.

(51) Int. Cl. C01B 3/04

(52) U.S. Cl. 423/658.2

(57) ABSTRACT

A method of producing hydrogen is provided that includes exposing a hydrogen-extracting (H-x) material to water, where the H-x material includes a crystal structure having interstitial space available for the insertion of protons and the water can be liquid water or vapor water. A spontaneous electrochemical reaction occurs, whereby water chemically decomposes in contact with the H-x material, the resulting hydrogen is stored in the H-x material and the resulting oxygen is emitted as a gas. This reaction proceeds until it is limited by a hydrogen loading capacity of the H-x material and/or the electrochemical potential of the H-x material relative to the water. The H-x material is heated to recover the stored hydrogen in a temperature range of 20 to 1000 degrees Celsius. This process is reversible, as it can be repeated many times. No electricity or consumable chemicals are required.

### CROSS-REFERENCE TO RELATED APPLICATIONS

This application is cross-referenced to and claims the benefit from U.S. Provisional Application 61/127922 filed May 16, 2008, and which are hereby incorporated by reference.

### FIELD OF THE INVENTION

The invention relates generally hydrogen production. More particularly, the invention relates to producing hydrogen by decomposing water and storing released hydrogen in a material for later release by heating.

### BACKGROUND

Hydrogen is of significant interest as an alternative energy source, so various methods for producing/storing hydrogen have been developed. However, known hydrogen production methods have various disadvantages. For example, cheap hydrogen can be produced from natural gas, but such hydrogen tends to contain impurities, such as CO, that poison fuel cell catalysts. The removal of these impurities is difficult and expensive.

Clean hydrogen can be produced, however, by the electrolysis of water, but this is expensive, due to problems with the impedance of the positive (oxygen side) electrode. This process requires about 2 volts, but the output of fuel cells is only 1.2 volts, so this is very inefficient and costly.

Accordingly, there is a need to develop a low-cost and clean method of producing hydrogen to overcome the current shortcomings in the art.

### SUMMARY OF THE INVENTION

The present invention provides a clean and affordable method of producing Hydrogen. The method of the current invention includes decomposing water into Hydrogen, Oxygen and heat by exposing a Hydrogen-extracting (H-x) material to the water, where the Hydrogen is stored in the H-x material, and releasing the stored Hydrogen by heating the H-x material.

According to one aspect of the invention, the H-x material includes a crystal structure having interstitial space available for the insertion of protons. Here, the insertion of protons stops when the interstitial space is saturated with the Hydrogen.

In another aspect of the invention, the H-x material absorbs additional electrons to balance the charge of inserted protons.

In a further aspect, the water can be liquid water or vapor water.

In yet another aspect of the invention, the H-x materials can be metal hydrides, metal alloys, oxide materials, transition metal oxides and oxy-fluorides containing alkali metals. Here, the metal alloy has a beta-Titanium structure. Further, the alkali metals can include lithium and/or sodium.

According to another aspect of the invention, the heating of the H-x material to release the stored Hydrogen is in a temperature range of 20 to 1000 degrees Celsius.

A key feature of the invention is the method can produce clean hydrogen repeatedly and inexpensively.

### BRIEF DESCRIPTION OF THE FIGURES

The objectives and advantages of the present invention will be understood by reading the following detailed description in conjunction with the drawing, in which:

FIG. 1 shows a flow diagram of the method of producing hydrogen according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

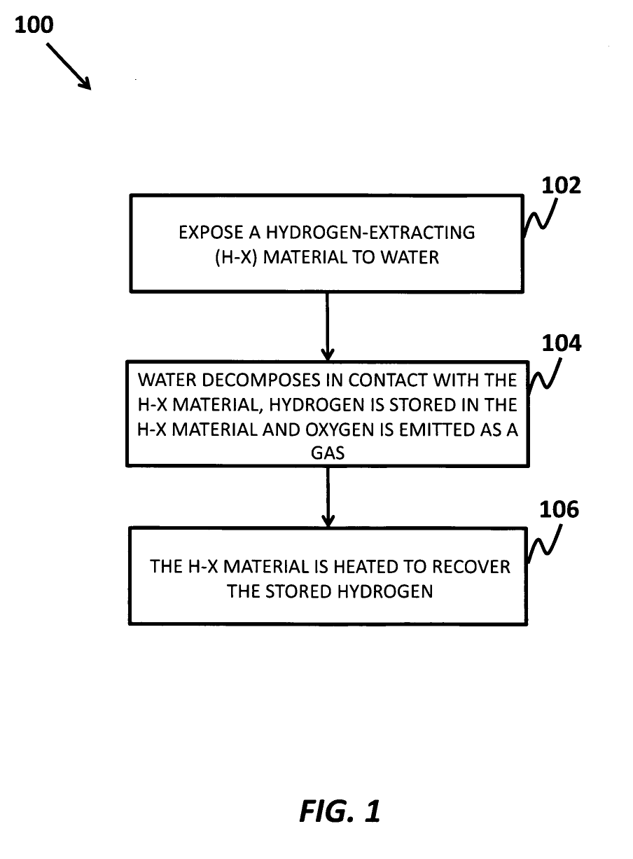

According to embodiments of the present invention, cheap and clean hydrogen is provided. FIG. 1 shows a flow diagram of the steps for producing clean and affordable hydrogen 100 that includes expose a hydrogen-extracting (H-x) material to water 102. The H-x material includes a crystal structure having interstitial space available for the insertion of protons. Here, the insertion of protons stops when the interstitial space is saturated with the Hydrogen. Further, the H-x material can absorb additional electrons. The H-x materials can be metal hydrides, metal alloys, oxide materials, transition metal oxides and oxy-fluorides containing alkali metals. Here, the metal alloy has a beta-Titanium structure. Further, the alkali metals can include lithium and/or sodium. Additionally, the water can be liquid water or vapor water. A spontaneous chemical reaction occurs, whereby water chemically decomposes in contact with the H-x material, the resulting hydrogen is stored in the H-x material, and the resulting oxygen is emitted as a gas 104. This reaction proceeds until it is limited by a hydrogen loading capacity of the H-x material and/or the electrochemical potential of the H-x material relative to the water. Next, the H-x material is heated 106 to recover the stored hydrogen. The heating of the H-x material to release the stored Hydrogen is in a temperature range of 20 to 1000 degrees Celsius. These steps are repeated in sequence to produce hydrogen from water. This process is reversible, as it can be repeated many times. No electricity or consumable chemicals are required. Aside from the active material, the only significant cost involved in this process is the heating of the hydrogen-absorbing material to drive off the hydrogen. In many cases this will involve a relatively low temperature, and such low temperature heat is very inexpensive. Many waste heat sources can be used for this purpose at essentially no cost.

There are four critical criteria for selecting the proper material according to the current invention. One is that the material has interstitial space in its crystal structure for the insertion of protons. A second is that it can absorb additional electrons. The third is that the kinetics of the insertion of protons and electrons is sufficiently fast, and the fourth is that it has an electrical potential that is positive of that of oxygen in water.

When such a material is put in contact with water, or even water vapor in the atmosphere, water is decomposed upon its surface, hydrogen (in the form of protons and electrons) enters its crystal structure, and oxygen gas is emitted.

Because of the addition of electrons, the electrical potential of this material decreases (becomes less positive) either until no more hydrogen can be absorbed or the potential of the water is reached.

One key aspect of the invention is the selection of H-x materials that can act as described above. For example, an alloy with the beta-Titanium structure having a composition of Cr_{0.41}Ti_{0.3}V_{0.23}Mn_{0.03}Fe_{0.03} is one material that may be used with the current method. After removing the oxide surface, and simply putting this material in contact with water, 3% hydrogen (by weight) is absorbed within it. This hydrogen is released reversibly from this alloy when it is heated to 110° C.

The key element in this process is the selection of the hydrogen-absorbing material. This behavior should be characteristic of a number of materials that are used as metal hydride electrodes in batteries, as well as some others that are interesting for the direct absorption and storage of hydrogen gas. It is understood that M-x materials suitable for practicing embodiments of the invention may be found at least among hydrogen storage alloys, oxide materials presently used as positive electrodes in Li batteries, and a family of transition metal oxides and oxy-fluorides containing alkali metals, such as lithium and/or sodium.

This family could include: LiₓCoPO₄; LiₓM oxides, M being any transition metal; LiₓM1M2 oxides, M1 and M2being any two different transition metals; alkali metal-containing transition metal oxyfluorides, such as LiₓMPO₄F, M being any transition metal; alkali metal-containing transition metal oxyfluorides, such as LiₓM1M2PO₄F, M1 and M2 being any two transition metals; and analogs of any of the preceding with Na instead of Li, or with both Li and Na. Further description of embodiments and variations of the invention, including further considerations for identification of suitable M-x materials, is provided in the following appendices.

In considering the use of metallic alloys, however, the possibility of corrosion and surface layers has to be considered. This can be addressed by the use of oxide materials that do not corrode in water.

According to the invention, a number of oxides used as positive electrodes in lithium batteries are useful for the extraction of hydrogen from water by the method described in FIG. 1. Typically, lithium batteries are assembled in air, i.e. in the discharged state. The positive electrode materials therefore contain lithium, which is transferred to the negative electrode when the cells are charged and are generally considered to be stable in air, although there is evidence that some of them react with atmospheric water. This becomes evident in their electrochemical behavior. The lithium is removed from these positive electrode materials when they are charged, leaving space in their crystal structures for protons, and the potential of these electrode materials becomes more positive and they become more reactive with water.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art.

All such variations are considered to be within the scope and spirit of the present invention as defined by the following claims and their legal equivalents.

What is claimed:

1. A method of producing Hydrogen comprising:
a. decomposing water into Hydrogen, Oxygen and heat by exposing a Hydrogen-extracting (H-x) material to said water, wherein said Hydrogen is stored in said H-x material; and
b. releasing said stored Hydrogen by heating said H-x material.

2. The method of producing Hydrogen of claim 1, wherein said H-x material comprises a crystal structure having interstitial space available for the insertion of protons.

3. The method of producing Hydrogen of claim 2, wherein said insertion of protons stops when said interstitial space is saturated with said Hydrogen.

4. The method of producing Hydrogen of claim 1, wherein said H-x material absorbs additional electrons to balance the charge of inserted protons.

5. The method of producing Hydrogen of claim 1, wherein said water comprises liquid water or vapor water.

6. The method of producing Hydrogen of claim 1, wherein said H-x material is selected from the group consisting of metal hydrides, metal alloys, oxide materials, transition metal oxides and oxy-fluorides containing alkali metals.

7. The method of producing Hydrogen of claim 6, wherein said metal alloy comprises a beta-Titanium structure.

8. The method of producing Hydrogen of claim 6, wherein said alkali metals comprise lithium and/or sodium.

9. The method of producing Hydrogen of claim 1, said heating of said H-x material to release said stored Hydrogen is in a temperature range of 20 to 1000 degrees Celsius.
